(19) United States
(12) Patent Application Publication
(10) Pub. No.: US 2008/0122917 A1
(43) Pub. Date: May 29, 2008

(54) THERMAL PRINTER AND PRINTING METHOD OF THERMAL PRINTER

(76) Inventor: Ken Higuchi, Kanagawa (JP)

Correspondence Address: David R. Metzger;SONNENSCHEIN NATH & ROSENTHAL LLP, Post Office Box 061080, Wacker Drive Station, Sears Tower, Chicago, IL, 60606-1080, US

(21) Appl. No.: 11/625,899

(22) Filed: Jan. 23, 2007

(30) Foreign Application Priority Data
Jan. 24, 2006 (JP) P2006-015579

(51) Int. Cl. B41J 2/325

(52) U.S. Cl. 347/215

(57) ABSTRACT

A thermal printer includes a conveying roller for conveying a recording sheet, a thermal head for transferring ink onto the recording sheet by driving a heating element, and a platen roller arranged to oppose the thermal head for pinching the ink ribbon and the recording sheet between the platen roller and the thermal head during ink transferring. The thermal printer prints images by transferring ink onto the recording sheet while the recording sheet pinched between the thermal head and the platen roller being conveyed, and the conveying roller is arranged upstream the platen roller in a feeding direction of the recording sheet. The platen roller can convey the recording sheet at least in the feeding direction by its rotation, and the printing is performed while the recording sheet being conveyed in the feeding direction by the cooperation of the conveying roller with the platen roller.

### CROSS REFERENCES TO RELATED APPLICATIONS

The present invention contains subject matter related to Japanese Patent Application JP 2006-015579 filed in the Japanese Patent Office on Jan. 24, 2006, the entire contents of which are incorporated herein by reference.

### BACKGROUND OF THE INVENTION

1. Field of the Invention

The present invention relates to thermal printers and printing methods by the thermal printers in that a recording sheet is printed by transferring ink thereon while being conveyed by the rotation of a conveying roller in a state pinched between a thermal head and a platen roller, and in particular it relates to a thermal printer and a printing method by the thermal printer that are capable of uniting the reduction in sheet scrap with the reduction in printing time.

2. Description of the Related Art

A thermal printer has been known that includes a conveying roller for conveying a recording sheet, a thermal head for transferring sublimation ink applied on an ink ribbon onto the recording sheet, and a platen roller arranged to oppose the thermal head. For printing images by such a thermal printer, the ink is transferred onto the sheet by selectively turning on electricity to a plurality of heater elements (heating resisters, for example) linearly arranged in the thermal head so as to use the thermal energy generated at this time.

That is, after the leading end of the recording sheet is fed to the point of the platen roller, the raised thermal head is lowered so as to pinch the recording sheet and the ink ribbon between the thermal head and the platen roller. Then, by rotating the conveying roller arranged downstream from the platen roller in the conveying direction of the recording sheet from the feed side toward the discharge side so as to convey the recording sheet in the conveying direction while selectively turning on electricity to the heater elements of the thermal head, the ink on the ink ribbon is sublimated with the thermal energy so as to transfer the ink onto the recording sheet.

The ink ribbon used in such a thermal printer herein is looped around between an unwind reel and a winder reel arranged within an ink cassette, and a plurality of different color inks (yellow (Y), magenta (M), and cyan (C), for example); and a transparent laminate ink (L) are sequentially and repeatedly applied on a base film in a direction perpendicular to the winding off direction of the ink ribbon. The color inks (Y, M, and C) are sequentially transferred onto the recording sheet and the laminate ink (L) is finally transferred thereon for protecting the printed images from a UV ray.

At this time, since the ink is transferred in a one-color unit, every change in color inks (Y, M, and C) to be transferred, the thermal head is raised and the recording sheet is conveyed to the starting point of printing in the returning direction. Hence, the conveying rollers (the capstan roller and the pinch roller), arranged downstream the platen roller, are reciprocally rotatable in a state of pinching the recording sheet, so that after the recording sheet is conveyed in the feeding direction by the normal rotation so as to be drawn out of the thermal head by pinching the leading end of the recoding sheet, it is repeated to convey the recording sheet in the returning direction by the reverse rotation. Then, after the laminate ink (L) is transferred, the recording sheet is conveyed in the feeding direction to a cutter arranged downstream the conveying rollers.

Therefore, the leading end of the recording sheet pinched by the conveying rollers (the capstan roller and the pinch roller) is spaced from the printing starting point of the recording sheet to be transferred with the ink from the thermal head by a predetermined distance due to the space between the conveying roller and the platen roller, so that the predetermined distance certainly remains as a blank space where is impossible to be printed. Hence, the blank space is cut off by the cutter, so that the printed recording sheet without the blank space is discharged. Obviously, the cut blank spaces are discarded in vain as sheet scraps. With larger blank spaces, the system becomes less preferable in cost and environment.

Then, for reducing the sheet scraps, various techniques for reducing the blank space have been proposed. Namely, a printer is known in that the ink ribbon and the recording sheet are conveyed to between the thermal head and the platen roller in a state where they are held between a platen sheet and a ribbon frame, which are made of rubber, so as to be printed (see Japanese Patent Publication No. 2536728, for example). According to the technique disclosed in such Patent, by pinching the platen sheet and the ribbon frame with the conveying rollers, the recording sheet can be conveyed, so that the blank space can be reduced.

Also, a thermal printer is known in that the recording sheet can be printed up to the leading end thereof by conveying in the returning direction while being printed in reverse to the feeding direction (see Japanese Unexamined Patent Application Publication No. 2001-353891, for example) According to the technique disclosed in such Patent, the recording sheet is printed while being conveyed in the returning direction from the starting point in the middle of the way of the printing to the leading end of the recording sheet (the completion point of the printing), and then, the recording sheet is cut at the starting point of the printing, so that images can be printed without the blank space.

### SUMMARY OF THE INVENTION

However, in the technique disclosed in Japanese Patent Publication No. 2536728, the ink ribbon and the recording sheet must be held in between the platen sheet and the ribbon frame ever one printing. Hence, although the sheet scraps can be reduced, the printing time increases. In addition, a mechanism is required for securely holding the ink ribbon and the recording sheet, so that the reliability of the mechanism and the reducing the increase in cost are needed.

Also, in the technique disclosed in Japanese Unexamined Patent Application Publication No. 2001-353891, although the sheet scraps can be reduced, there is a problem that the printing time increases. That is, in the above-technique, the recording sheet is printed while being conveyed in the returning direction, so that the number of reciprocating times for printing increases, resulting in the increase in printing time.

Then, the relationship between such a conveying direction of the recording sheet and the increase in printing time will be described in detail.

FIG. 8 is a side view of an internal structure of a conventional thermal printer 100 according to the technique in Japanese Unexamined Patent Application Publication No. 2001-353891.

As shown in FIG. 8, on the rear side of a door 103 of the thermal printer 100, a thermal head 110 is arranged having a plurality of heating elements (heating resisters, for example). Within a casing 102, a platen roller 111 is arranged at a position opposing the thermal head 110 when the door 103 is closed.

Upon mounting an ink ribbon 31 on the casing 102, a unwind reel 32 is positioned below the platen roller 111 while a winder reel is positioned above the platen roller 111. Then, the ink ribbon 31 passes over the platen roller 111, so that if the door 103 is closed, the ink ribbon 31 is pinched between the platen roller 111 and the thermal head 110.

Within the casing 102, a roll paper 41 made of a recording sheet wound around cylindrically is held with a paper holder 42. Then, the wound-off roll paper 41 passes between conveying rollers (a capstan roller 112 and a pinch roller 113) arranged upstream the platen roller 111 in the feeding direction of the roll paper 41, and then it passes between the thermal head 110 and the platen roller 111, so as to be discharged.

FIG. 9 is a flowchart showing the printing operation of the conventional thermal printer 100 shown in FIG. 8.

As shown in FIG. 9, after starting operation, the roll paper 41 is fed at first Step S101; upon receiving the printing instruction at next Step S102, the ink ribbon 31 (Yellow Y) is printed at next Step S103 and at Step S104.

That is, at Step S103, by counterclockwise rotating the capstan roller 112 (see FIG. 8), the leading end of the roll paper 41 is fed to the point of the thermal head 110 (see FIG. 8) so that the print starting point in the middle of the way of the roll paper 41 opposes the heating element of the thermal head 110. Thereafter, the thermal head 110, which has been raised, is lowered so as to pinch the ink ribbon 31 and the roll paper 41 between the heating element of the thermal head 110 and the platen roller 111.

At sequential Step S104, by clockwise rotating the capstan roller 112 in reverse, the roll paper 41 is returned to its leading end in the reverse direction to that at Step S103. Also, by clockwise rotating the winder reel 33 (see FIG. 8), the ink ribbon 31 is wound at the same speed and in the same direction as those of the roll paper 41. Simultaneously, the heating element arranged in the thermal head 110 is selectively driven by turning on electricity, so that the color ink (Y) is printed on the roll paper 41 ranging from the print starting point to the completion point of the printing by applying thermal energy to the ink ribbon 31.

Accordingly, in the conventional thermal printer 100 shown in FIG. 8, at Step S103, the roll paper 41 is fed to the print starting point; at Step S104, the roll paper 41 is returned to be printed, so that the roll paper 41 makes one reciprocation with feeding and returning for printing the ink ribbon 31(yellow Y) thereon.

Similarly, at Step S105, the roll paper 41 is fed to the print starting point; at Step S106, the roll paper 41 is returned to print the ink ribbon 31(magenta M) thereon, so that the roll paper 41 makes two reciprocations up to here including printing yellow (Y). Furthermore, at Step S107, the roll paper 41 is fed to the print starting point; at Step S108, the roll paper 41 is returned to print the ink ribbon 31 (cyan C) thereon, so that the roll paper 41 makes a third reciprocation at this time. Furthermore, at Step S109, the roll paper 41 is fed to the print starting point; at Step S110, the roll paper 41 is returned to transfer the ink ribbon 31 (laminate L) thereon, so that the roll paper 41 makes a fourth reciprocation at this time.

In such a manner, in the conventional thermal printer 100 shown in FIG. 8, the color inks (Y, M, and C) are printed and then, the laminate ink (L) is transferred, so that the roll paper 41 must make four reciprocations. The transferring of the laminate ink (L), as mentioned above, is performed while the roll paper 41 being returned, so that for cutting the roll paper 41 after the completion of printing, the print finishing point of the roll paper 41 has to be fed to the cutting position at Step S111. Then, the roll paper 41 has made four and half reciprocations up to this time, and thereafter, the roll paper 41 is cut and discharged at final Step S112 to complete printing.

As a result, in the conventional thermal printer 100, from the print starting to the completion, the roll paper 41 has to make four and half reciprocations including the feeding the roll paper 41 after the print completion, so that the number of reciprocations of the roll paper 41 becomes very large. In order to reduce the number of reciprocations of the roll paper 41 herein, the printing may be performed while the roll paper 41 being fed, not being returned; however, in this case, the blank space is largely formed so that as described above, sheet scraps of the roll paper 41 are largely generated in vain.

Accordingly, it is desirable to provide a thermal printer for printing images by transferring ink onto a recording sheet pinched between a thermal head and a platen roller while the recording sheet being conveyed by a conveying roller, the thermal printer being capable of reducing sheet scraps generated by the printing and reducing the printing time.

According to an embodiment of the present invention, there is provided a thermal printer including a conveying roller for conveying a recording sheet; a thermal head for transferring ink on an ink ribbon onto the recording sheet by driving a heating element with turning on electricity; and a platen roller arranged to oppose the thermal head for pinching the ink ribbon and the recording sheet between the platen roller and the thermal head during ink transferring. The thermal printer prints images by transferring ink onto the recording sheet while the recording sheet pinched between the thermal head and the platen roller being conveyed by the rotation of the conveying roller, and the conveying roller is arranged upstream the platen roller in a feeding direction of the recording sheet ranging from the feed side toward the discharge side, and the platen roller can convey the recording sheet at least in the feeding direction by its rotation, and the printing is performed while the recording sheet being conveyed in the feeding direction by the cooperation of the conveying roller with the platen roller.

According to the embodiment of the present invention, there is provided another thermal printer including a conveying roller for conveying a recording sheet, a thermal head for transferring ink on an ink ribbon onto the recording sheet by driving a heating element with turning on electricity, and a platen roller arranged to oppose the thermal head for pinching the ink ribbon and the recording sheet between the platen roller and the thermal head during ink transferring. The thermal printer prints images by transferring ink onto the recording sheet while the recording sheet pinched between the thermal head and the platen roller being conveyed by the rotation of the conveying roller, and the conveying roller is arranged upstream the platen roller in a feeding direction of the recording sheet ranging from a feed side toward a discharge side, and the thermal printer further includes a pair of upper and lower guide members arranged between the conveying roller and the platen roller for restricting positions on the front face and rear face side of the recording sheet, and the thermal printer prints images while the recording sheet being conveyed by the rotation of the conveying roller in the feeding direction of the recording sheet via between the guide members.

In the thermal printer according to the embodiment of the present invention, the conveying roller is arranged upstream the platen roller in the feeding direction of the recording sheet ranging from the feed side toward the discharge side. By the rotation of the platen roller, the recording sheet can be conveyed in the feeding direction, so that the printing is performed while the recording sheet being conveyed in the feeding direction by the cooperation of the conveying roller with the platen roller. Therefore, even when the recording sheet is conveyed in the feeding direction, the recording sheet can be securely conveyed without buckling. In comparison with a case where the printing is performed while the recording sheet being conveyed in the returning direction, the number of reciprocations required for the printing can be reduced. Moreover, the end portion of the recording sheet can be the print starting point.

In the other thermal printer according to the embodiment of the present invention, the conveying roller is also arranged upstream the platen roller in the feeding direction of the recording sheet ranging from the feed side toward the discharge side. In this thermal printer, there is provided a pair of upper and lower guide members arranged between the conveying roller and the platen roller for restricting positions on the front face and rear face side of the recording sheet so as to print images while the recording sheet being conveyed by the rotation of the conveying roller in the feeding direction of the recording sheet via between the guide members. Therefore, even when the recording sheet is conveyed in the feeding direction, the recording sheet can be securely conveyed without buckling. In comparison with a case where the printing is performed while the recording sheet being conveyed in the returning direction, the number of reciprocations required for the printing can be reduced. Moreover, the end portion of the recording sheet can be the print starting point.

According to the embodiment, the printing is performed while the recording sheet being conveyed in the feeding direction, so that in comparison with a case where the printing is performed while the recording sheet being conveyed in the returning direction, the number of reciprocations required for the printing can be reduced so as to reduce the printing time. Moreover, the end portion of the recording sheet can be the print starting point, so that blank spaces can be almost eliminated, reducing sheet scraps.

Accordingly, according to the embodiment, the thermal printer can combine the reduction in sheet scrap with the reduction in printing time.

### BRIEF DESCRIPTION OF THE DRAWINGS

FIG. 1 is a perspective view of a thermal printer according to an embodiment;

FIG. 2 is a perspective view of the thermal printer according to the embodiment shown in FIG. 1, showing a state of a door of the thermal printer being opened and of an ink cassette being taken out;

FIG. 3 is a plan view of an ink ribbon used in the thermal printer according to the embodiment shown in FIG. 1;

FIG. 4 is a schematic side view of the internal structure of the thermal printer according to the embodiment shown in FIG. 1;

FIG. 5 is a flowchart showing the printing operation of the thermal printer according to the embodiment shown in FIG. 1;

FIG. 6 is a side view showing the vicinity of the thermal head shown in FIG. 4 and a state at Steps S3, S5, and S7 in the flowchart of FIG. 5;

FIG. 7 is a side view showing the vicinity of the thermal head shown in FIG. 4 and a state at Step S10 in the flowchart of FIG. 5;

FIG. 8 is a side view of the internal structure of a conventional thermal printer; and

FIG. 9 is a flowchart showing the printing operation of the conventional thermal printer shown in FIG. 8.

### DESCRIPTION OF THE PREFERRED EMBODIMENTS

An embodiment of the present invention will be described below with reference to the drawings.

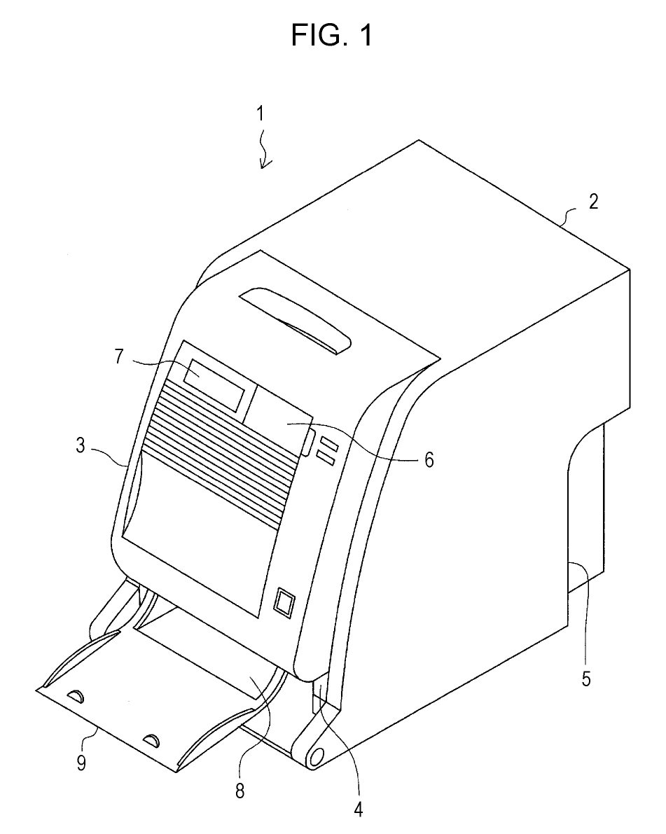

FIG. 1 is a perspective view of a thermal printer 1 according to the embodiment.

As shown in FIG. 1, the thermal printer 1 includes a casing 2 and a door 3 attached on the front face of the casing 2. Below the door 3, an outlet 8 is formed, to which a discharge tray 9 is attached.

On the front side of the casing 2, a power switch 4 is provided. On the rear side of the casing 2, an interface 5 composed of a plurality of connectors for external connection is arranged. Image information and so forth can be obtained from a computer through the interface 5. The image information may also be read by connecting various recording media, such as a magnetic disk, an optical disk, and a memory card, to the interface 5, not from the computer.

On the other hand, on the door 3, an operation panel 6 is provided for setting the printing in the thermal printer 1. The information obtained from the interface 5 or inputted or selected by the operation panel 6 and other various messages are displayed on a liquid crystal panel 7.

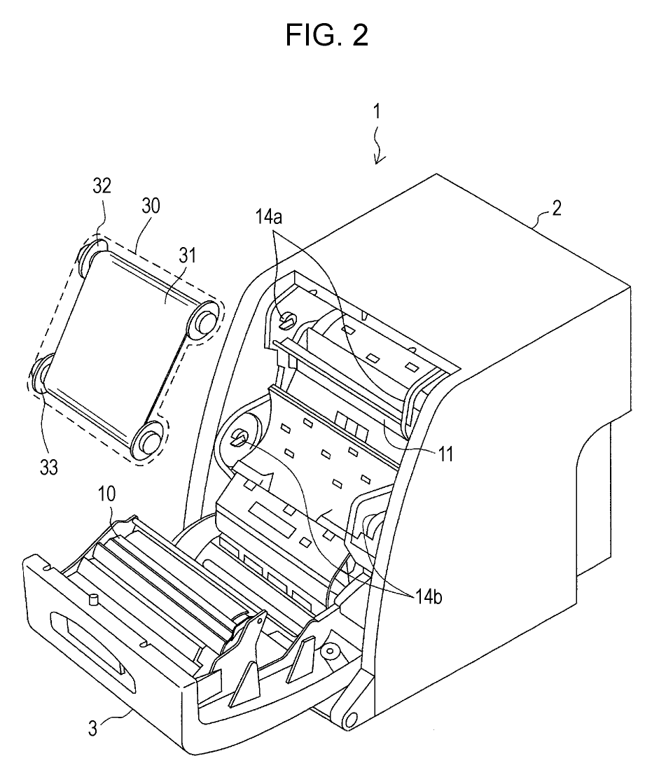

FIG. 2 is a perspective view of the thermal printer 1 according to the embodiment shown in FIG. 1 in a state in that the door 3 is opened and an ink cassette 30 is taken out; the outer shape of the ink cassette 30 is shown with dotted lines for clearly showing its internal structure.

As shown in FIG. 2, a thermal head 10 is arranged on the rear side of the door 3. On the other hand, within the casing 2, a platen roller 11 is arranged at a position opposing the thermal head 10 when the door 3 is closed.

Within the casing 2, above the platen roller 11, reel driving means 14a is provided for rotating a feed reel 32 of the ink cassette 30. Furthermore, below the platen roller 11, reel driving means 14b is provided for rotating a winding reel 33 of the ink cassette 30.

When the ink cassette 30 is mounted on the casing 2, an ink ribbon 31 is arranged so as to pass through over the platen roller 11. Furthermore, when the door 3 is closed, the ink ribbon 31 is positioned between the thermal head 10 and the platen roller 11. When the reel driving means 14b is driven in this state, the ink ribbon 31 is wound around the winding reel 33.

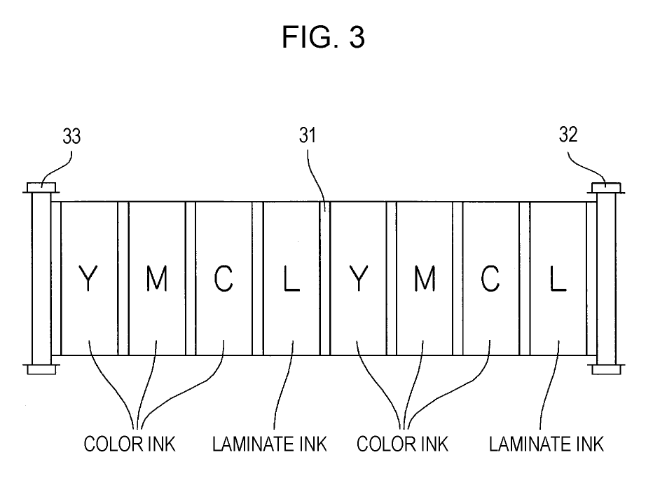

FIG. 3 is a plan view of the ink ribbon 31 used in the thermal printer 1 according to the embodiment shown in FIG. 1.

As shown in FIG. 3, the ink ribbon 31 is looped around between the feed reel 32 and the winder reel 33 arranged within the ink cassette 30 (see FIG. 2). Color inks (sublimation dyes) yellow (Y), magenta (M), and cyan (C); and a transparent laminate ink (L) are sequentially and repeatedly applied on a zonal plastic resin film in a direction perpendicular to the winding off direction of the ink ribbon 31. The laminate ink (L) protects printed images from a UV ray so as to improve the light stability by covering the printed images formed by the color inks (Y, M, and C).

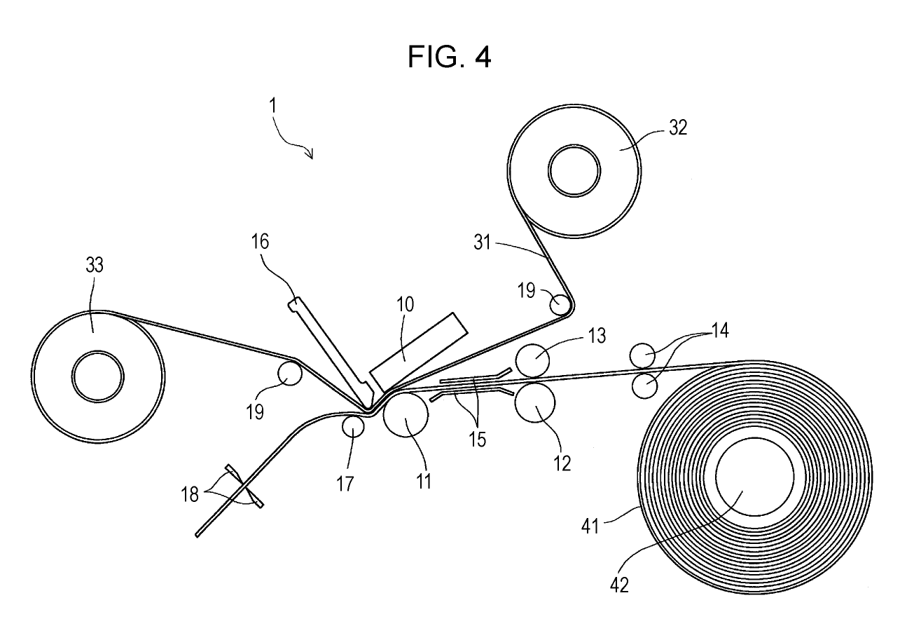

FIG. 4 is a schematic side view of the internal structure of the thermal printer 1 according to the embodiment shown in FIG. 1.

Within the casing 2 shown in FIG. 1, a roll paper 41 (a recording sheet according to the present invention and wound around cylindrically) is held with a paper holder 42 as shown in FIG. 4. Then, the roll paper 41, wound off by a feed roller pair 14 on demand, passes between a capstan roller (drive roller) 12 and a pinch roller (follower roller) 13, which are arranged upstream the thermal head 10 and the platen roller 11 in the feeding direction of the roll paper 41 (to the left in FIG. 4), and then it passes between the thermal head 10 and the platen roller 11, so as to be cut by a cutter 18 and discharged.

The capstan roller 12 and the pinch roller 13 herein are equivalent to conveying rollers according to the present invention. By rotating the capstan roller 12 in a forward/reversal direction according to need, the roll paper 41 can be conveyed in a feeding/returning direction. In the thermal printer 1 according to the embodiment, the platen roller 11 is also rotated so as to convey the roll paper 41 in the feeding direction.

The conveying the roll paper 41 in the feeding direction is made by cooperation of the capstan roller 12 with the capstan roller 12. At this time, the driving mechanism of the platen roller 11 is provided with a torque limiter attached thereto and the peripheral speed of the platen roller 11 during free rotation is set faster than that of the capstan roller 12, so that when the roll paper 41 is conveyed in the feeding direction, a tension is always applied in the roll paper 41 between the capstan roller 12 and the platen roller 11. Hence, the roll paper 41 is not slackened so as to prevent conveying troubles such as buckling, securing printing operation.

Between the conveying rollers (the capstan roller 12 and the pinch roller 13) and the platen roller 11, a pair of conveying guides 15 (corresponding to guide members according to the present invention) are arranged for restricting front-face (recording surface) and rear-face positions of the roll paper 41. Each of the conveying guides 15 is partly formed in parallel with a tangent line connecting between the capstan roller 12 and the platen roller 11 so as to guide the conveyed roll paper 41 onto the platen roller 11. In addition to the cooperation of the capstan roller 12 with the capstan roller 12, owing to the positional restriction by the conveying guides 15, the roll paper 41 can be securely fed between the thermal head 10 and the platen roller 11 without rampaging due to changes in load or without buckling due to collision of the paper leading end to the platen roller 11 during paper feeding.

On the other hand, the ink ribbon 31 is unwound out of the feed reel 32 in accordance with color-converted gradation data and then is rewound by the winder reel 33 through two guide rollers 19. Hence, the ink ribbon 31 and the roll paper 41 are pinched between the thermal head 10 and the platen roller 11 in a descended state of the thermal head 10, so that the thermal head 10 presses the front face (the recording surface) of the roll paper 41 with the ink ribbon 31 therebetween.

The thermal head 10 is provided with a plurality of heating resistors (corresponding to heating elements according to the present invention) arranged in line in the width direction (the line direction) of the roll paper 41. When the roll paper 41 and the ink ribbon 31 are conveyed in the feeding direction, by selectively turning on the heating resistor of the thermal head 10 with electricity, the color inks Y, M, and C applied on the ink ribbon 31 are transferred on the recording surface of the roll paper 41 using thermal energy generated by the turning on of electricity. Similarly, the laminate ink (L) of the ink ribbon 31 is covered on the printed images.

The ink ribbon 31, from which the ink has been transferred on the roll paper 41 when the ink ribbon 31 is overlapped with the roll paper 41 in between the thermal head 10 and the platen roller 11, is peeled off the roll paper 41 by a ribbon separating member 16 arranged downstream the thermal head 10 and the platen roller 11 in the feeding direction of the roll paper 41 and then is rewound around the winder reel 33.

The ribbon separating member 16 is a guide member for changing the conveying direction of the ink ribbon 31 at a steep angle. That is, upon completion of the ink transfer, the ink ribbon 31 becomes strongly stuck on the roll paper 41 due to the pressure and the heat of the thermal head 10. Then, the ink ribbon 31 is peeled off the roll paper 41 by making the edge of the blade-like ribbon separating member 16 abut the ink ribbon 31 so as to separate the ink ribbon 31 at a predetermined angle to the feeding direction of the roll paper 41.

On the other hand, the roll paper 41 is bent in a direction opposite to that of curl produced on the roll paper 41 (upward in FIG. 4) by a de-curl roller 17 corresponding to curl correcting means according to the present invention) for correcting the curl. Thereafter, the roll paper 41 is cut into predetermined sizes by the cutter 18 and discharged.

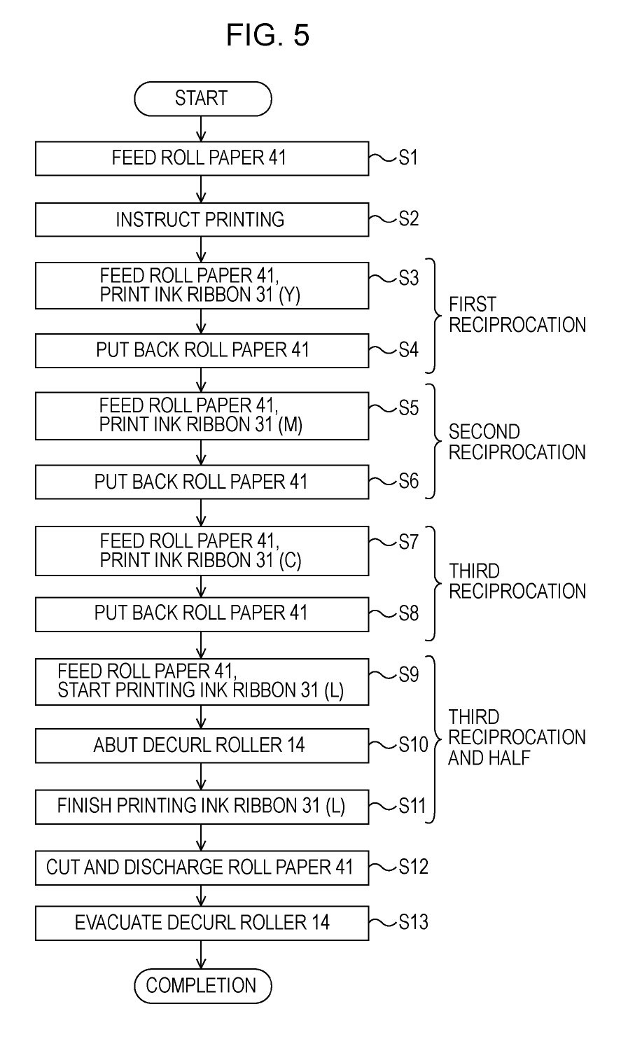

FIG. 5 is a flowchart of the printing operation of the thermal printer 1 according to the embodiment shown in FIG. 1.

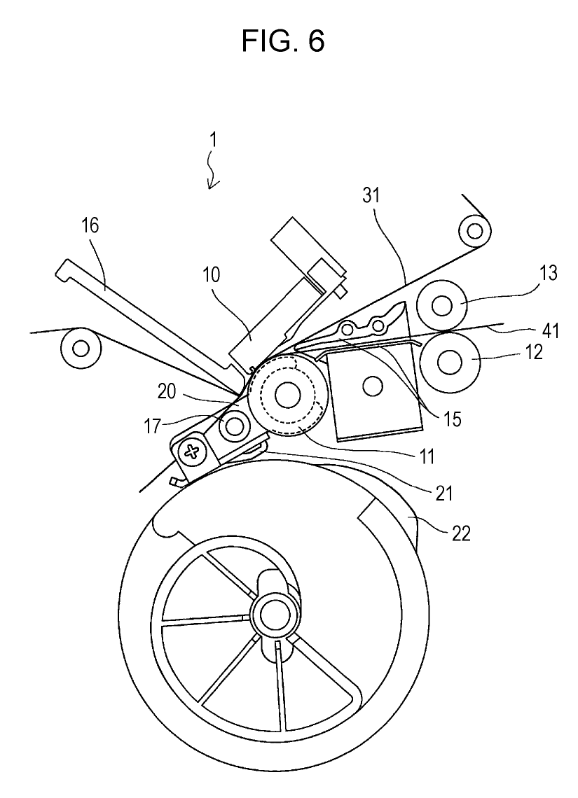

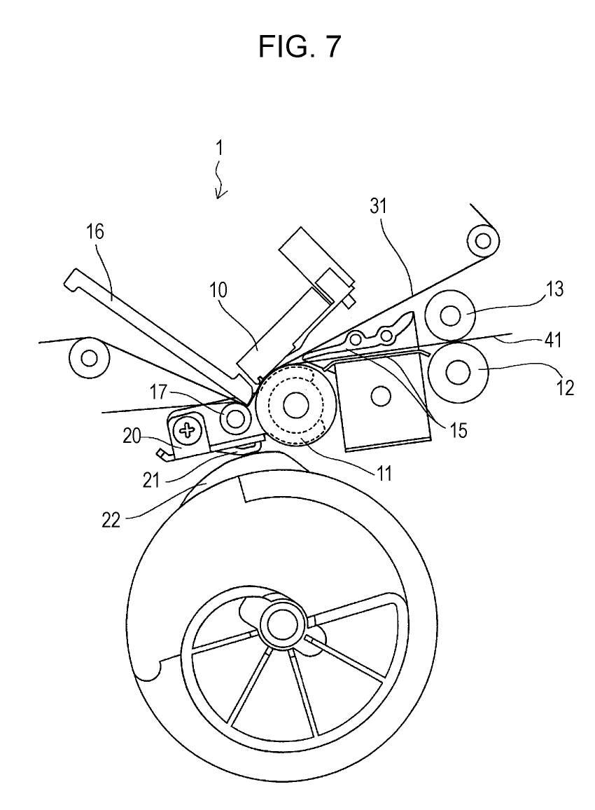

FIGS. 6 and 7 are side views showing the vicinity of the thermal head 10 shown in FIG. 4; FIG. 6 shows the state at Step S3, Step S5, and Step S7 in the flowchart of FIG. 5; and FIG. 7 shows the state at Step S10 in the flowchart.

As shown in FIG. 5, after print starting, the roll paper 41 (see FIG. 4) is rewound and fed at first Step S1 by rotating the roll paper 41; upon receiving the printing instruction at next Step S2, the ink ribbon 31 (Yellow Y) (see FIG. 3) is printed at next Step S3. Normally, the roll paper 41 has been already fed so as to wait over the platen roller 11 (see FIG. 4), so that the printing is executed at Step S3 by the printing instruction at Step S2 without passing through Step S1.

At Step S3, by counterclockwise rotating the capstan roller 12 shown in FIG. 6, the roll paper 41 pinched to the pinch roller 13 is fed toward the platen roller 11 via between the conveying guides 15. Also, the platen roller 11 is counterclockwise rotated. At this time, when a sensor (not shown) detects the leading end (the starting point of printing) of the roll paper 41, the number of steps of a motor (not shown) for driving the platen roller 11 is counted. When the counted number reaches a predetermined number, the heating resistor of the thermal head 10 is driven by turning on electricity. Then, the thermal head 10, which has been raised, is lowered so as to pinch the ink ribbon 31 and the roll paper 41 between the heating resistor of the thermal head 10 and the platen roller 11.

Then, from this state, the roll paper 41 is fed in a feeding direction of the roll paper 41 from the feeding side toward the discharging side (to the left in FIG. 6) by counterclockwise rotating the platen roller 11 and the capstan roller 12 with the cooperation of the capstan roller 12 with the capstan roller 12. Thereby, a tension is applied on the roll paper 41, so that the roll paper 41 is smoothly conveyed in the feeding direction from the print starting point to the print completion point while being pinched between the thermal head 10 and the platen roller 11 and being positionally restricted by the conveying guides 15.

While the roll paper 41 being conveyed, the ink ribbon 31 is also rewound at the same direction and speed as those of the roll paper 41 by counterclockwise rotating the winder reel 33 (see FIG. 4). Then, the color ink (Yellow Y) of the ink ribbon 31 is transferred on the roll paper 41 sequentially from the end portion (the print starting point) due to the thermal energy applied to the ink ribbon 31 from the heating resistor of the thermal head 10.

At this time, as described above, the heating resistor is driven before the thermal head 10 pinches the roll paper 41, and the end portion (the print starting point) of the roll paper 41 at this time is immediately adjacent to a portion pinched between the thermal head 10 and the platen roller 11, so that the transferring is executed slightly before the roll paper 41 is pinched. Hence, in the thermal printer 1 according to the embodiment, the color ink (Yellow Y) can be printed on the roll paper 41 from the print starting point to the print completion point absolutely without forming a blank space in the leading end portion of the roll paper 41. While the color inks (Y, M. and C) are printed, the de-curl roller 17 is located at an evacuated position as shown in FIG. 6 so as not to bend the roll paper 41.

After the color ink (Yellow Y) is printed in such a manner, at next Step S4, the preparation is made for printing the color ink (Magenta M) at Step S5. That is, since in the color printing, the transferring of the color ink is executed every color, after the thermal head 10, which has been lowered, is raised every change of color to be transferred so as to cancel the pressurizing the roll paper 41 by the thermal head 10, the roll paper 41 is returned to the print starting point by clockwise rotating the capstan roller 12 in reverse. In addition, the platen roller 11 is provided with a one-way clutch (not shown) assembled between the rotational shaft and the motor, and the platen roller 11 rotates following the returning of the roll paper 41, so that additional loads cannot be applied to the capstan roller 12 and the roll paper 41.

Accordingly, in the thermal printer 1 according to the embodiment, at Step S3, the printing is performed up to the print completion point while the roll paper 41 being fed from the feeding side toward the discharging side (to the left in FIG. 6), and then, at Step S4, the roll paper 41 is returned to the print starting point, so that the roll paper 41 makes one reciprocation with feeding and returning the roll paper 41 for printing the color ink (Yellow Y) of the ink ribbon 31.

At next Step S5, in the same manner as at Step S3, the color ink (Magenta M) is printed while the roll paper 41 being fed from the print starting point to the print completion point. At Step S6, in the same manner as at Step S4, the roll paper 41 is returned to the print starting point. Therefore, the color ink (Magenta M) is printed at a second reciprocation. At Step S7, the color ink (Cyan C) is printed while the roll paper 41 being fed to the print completion point, and at Step S8, the roll paper 41 is returned to the print starting point, so that the color ink (Cyan C) is printed at a third reciprocation of the roll paper 41.

Furthermore, at Step S9 and Step S11, the laminate ink (L) of the ink ribbon 31 is transferred while the roll paper 41 being fed to the print completion point. This laminate ink (L) is finally transferred, so that the returning the roll paper 41 required for the transferring the next ink is unnecessary. That is, after the roll paper 41 is fed to the print completion point in the feeding direction for transferring the laminate ink (L), by continuously conveying the roll paper 41 in the feeding direction, the roll paper 41 can be cut at the print completion point for discharging without returning the roll paper 41.

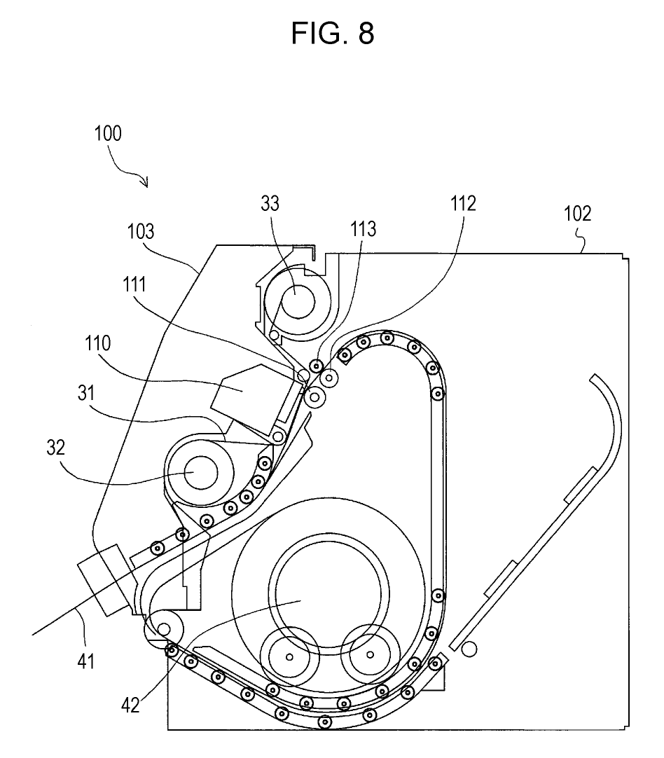

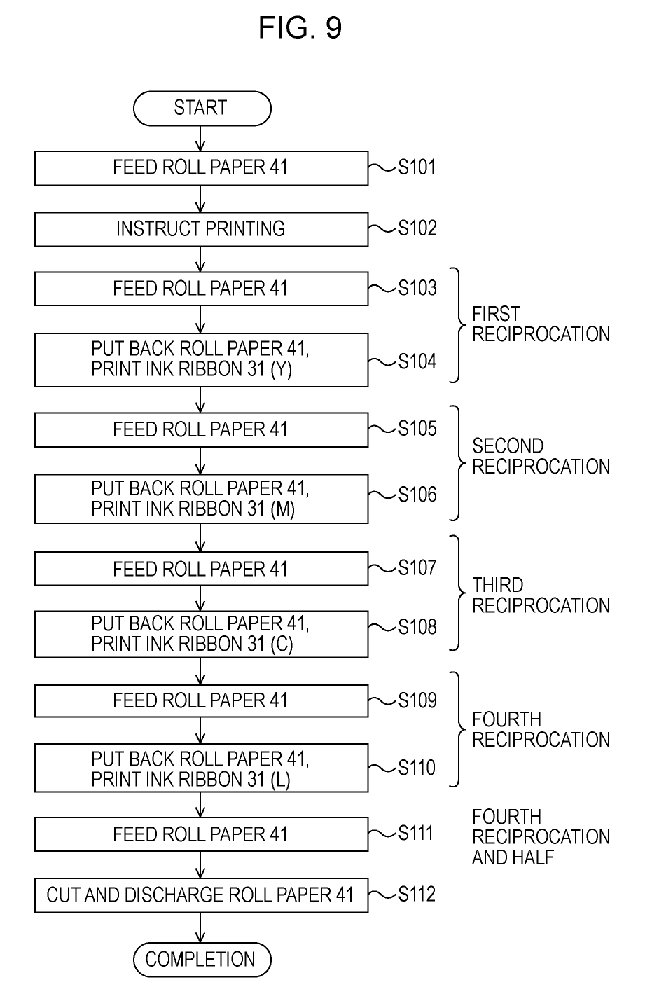

In such a manner, in the thermal printer 1 according to the embodiment, although the roll paper 41 must make three reciprocations for printing the color inks (Y, M, and C), when the final laminate ink (L) is transferred and the roll paper 41 is discharged, the returning the roll paper 41 is not required. Therefore, the roll paper 41 makes three and half reciprocations from the print starting to the completion of the printing, so that the printing time in the thermal printer 1 according to the embodiment can be reduced by one reciprocation in comparison to the conventional thermal printer 100 (see FIGS. 8 and 9) which requires to make four and half reciprocations.

Also, in the thermal printer 1 according to the embodiment, immediately after the transferring the laminate ink (L) at Step S9 (print starting), at Step S10, the de-curl roller 17 abuts the rear side of the roll paper 41 as shown in FIG. 7 so as to correct the curl produced on the roll paper 41 by upward bending the roll paper 41.

The de-curl roller 17 is a metallic roller that is rotated by abutting the conveyed roll paper 41 to follow the roll paper 41, and its rotating axis is supported by a support arm 20. The support arm 20 is swingable about the rotation shaft of the platen roller 11, to which one end of the de-curl roller 17 is fitted, and the de-curl roller 17 is attached to the other end as a free end. Hence, the de-curl roller 17 swings about the rotation shaft of the platen roller 11 to be able to abut to or separate from the roll paper 41.

In order to make the de-curl roller 17, which has been located at the evacuating position shown in FIG. 6, abut the roll paper 41, a cam 22 is counterclockwise rotated from the state of FIG. 6 to the sate of FIG. 7 so as to raise a cam follower 21 of the support arm 20. Then, the de-curl roller 17 is raised to abut the rear side of the roll paper 41. Up to Step S9, the cam 22 is separated from the cam follower 21 so that the de-curl roller 17 is located at the evacuating position and does not abut the roll paper 41; at Step S10, when the end portion of the roll paper 41 passes through the ribbon separating member 16, the cam 22 is rotated so as to make the de-curl roller 17 abut the rear side of the roll paper 41, as shown in FIG. 7, for correcting the curl of the roll paper 41.

That is, the roll paper 41, as shown in FIG. 4, is made of the recording sheet wound around with its recording surface facing the outside, and it develops a curl convex on the front face side (the recording surface side). Hence, when the roll paper 41 having the laminate ink (L) transferred on the recording surface at Step S9 is discharged as it is, the curl convex on the front face side directly remains. Then, at Step S10, for bending the roll paper 41 in a direction opposite to that of the curl produced on the roll paper 41 (the concave direction on the front face side and upward in FIG. 7), the de-curl roller 17 is abutted on the rear side of the roll paper 41.

Moreover, the de-curl roller 17 is arranged downstream the platen roller 11 in the feeding direction of the roll paper 41 (to the left in FIG. 7) as well as immediately adjacent to the ribbon separating member 16. In other words, the de-curl roller 17 is arranged close to the thermal head 10 using a space downstream the platen roller 11 unoccupied by arranging the capstan roller 12 upstream the platen roller 11. Accordingly, at the abutting position of the de-curl roller 17 to the roll paper 41, the after heat due to the thermal head 10 during the transferring the laminate ink (L) remains in the roll paper 41.

When the roll paper 41 is bent in a direction opposite to that of the curl (upward in FIG. 7) by making the de-curl roller 17 abut the rear face side of the roll paper 41 in a state of the after heat remaining in the roll paper 41, the roll paper 41 is deformed before the completion of the thermal contraction of materials constituting the roll paper 41 and the moisture loss, so that the same effect as the case where curl is corrected by heating paper can be obtained. Hence, the curl of the roll paper 41 can be securely corrected. Also, the curl can be efficiently corrected without arranging heating means such as a heater.

The degree of the curl produced in the roll paper 41 varies with the environmental conditions during printing (temperature, humidity, etc.), the material of the roll paper 41, the conveying speed of the roll paper 41, and the outer diameter of the roll paper 41. In the thermal printer 1 according to the embodiment, the bending degree of the roll paper 41 is changed in accordance with the curl degree produced on the roll paper 41 so as to adjust the curl correction. Specifically, as shown in FIG. 7, the surface of the cam 22 is inclined, so that by adjusting the rotational angle on the basis of the environmental conditions during printing, the material of the roll paper 41, the conveying speed, and the roll diameter, the lift degree of the cam follower 21 by the cam 22 can be continuously changed.

For example, the shape and degree of the curl of the roll paper 41 gradually change from the roll tongue toward the core, and the degree of the curl becomes marked toward the roll core. By bending the roll paper 41 so much for that with the de-curl roller 17, the curl can be uniformly corrected so as to stabilize the state of the roll paper 41 during discharging. The curl can also be corrected by user's preference according to setting.

After print starting at Step S9, the curl is corrected in such a manner at Step S10, and the roll paper 41 is finished printing at Step S11, and then it is cut by the cutter 18 (see FIG. 4) at Step S12 for discharging. The discharged roll paper 41 has high quality due to the corrected curl, and does not scatter in the vicinity of the outlet 8 (see FIG. 1). In the thermal printer 1 according to the embodiment, during cutting the roll paper 41, the roll paper 41 is cut at positions slightly on this and the other side of the boundary between the print completion point and an unprinted portion. Accordingly, the curl of the roll paper 41 is not only corrected but also the size of sheet scraps can be reduced to about few millimeters.

At final Step S13, the cam 22 is reversely rotated from the state of FIG. 7 to that of FIG. 6 so as to lower the de-curl roller 17 for moving it to the evacuation position, so that the printing is finished in a state in that the next printing is not disturbed. In the thermal printer 1 according to the embodiment, sheet scraps with a size of few millimeters are generated; however, no scrap can also be generated.

Therefore, the thermal printer 1 according to the embodiment can combine the reduction in sheet scrap with the reduction in printing time. That is, even when the conveying rollers (the capstan roller 12 and the pinch roller 13) are arranged upstream the platen roller 11, by the cooperation of the capstan roller 12 with the platen roller 11, the printing can be performed while the roll paper 41 being conveyed in the feeding direction. Hence, the blank space, generated due to the conveying of the roll paper 41 with conveying rollers arranged downstream the platen roller 11, can be eliminated, so that the sheet scraps can be reduced to be an only slight amount for ordering the vicinity of the boundary between the print completion point and an unprinted portion. In comparison with the printing while the roll paper 41 being conveyed in the returning direction, the number of reciprocations between the print stating and the print completion can be reduced by one reciprocation, reducing the printing time.

Furthermore, in the thermal printer 1 according to the embodiment, in a state of after heat during printing remaining in the roll paper 41, the de-curl roller 17 bends the roll paper 41 in a direction opposite to that of the curl, so that the curl can be efficiently corrected with a broad adjusting range with a compact mechanism and without additional heating means and loads applied to parts cost and manufacturing cost. The printing quality such as durability can be obtained by suppressing mechanical and thermal damage applied to the roll paper 41 to the minimum.

The embodiment of the present invention has been described; however, the present invention is not limited to the above-embodiment, so that various modifications can be made as follows, for example:

(1) The roll paper 41 is used as a recording sheet according to the embodiment; alternatively, a cut sheet may also be used; that is, even in the cut sheet, the printing time can be reduced; and curl may be produced even in the cut sheet and the curl can be efficiently corrected.
(2) According to the embodiment, while the platen roller 11 being cooperated with the capstan roller 12, the conveying guides 15 are also arranged; it is not necessarily to provide both the conveying rollers and the conveying guides 15 and any one of the both may be provided; that is, by only the cooperation of the platen roller 11 with the capstan roller 12, the roll paper 41 may be smoothly conveyed, and by arranging only the conveying guides 15, the roll paper 41 may also be smoothly conveyed.

It should be understood by those skilled in the art that various modifications, combinations, sub-combinations and alterations may occur depending on design requirements and other factors insofar as they are within the scope of the appended claims or the equivalents thereof.

What is claimed is:

1. A thermal printer comprising:
a conveying roller for conveying a recording sheet;
a thermal head for transferring ink on an ink ribbon onto the recording sheet by driving a heating element with turning on electricity; and
a platen roller arranged to oppose the thermal head for pinching the ink ribbon and the recording sheet between the platen roller and the thermal head during ink transferring,
wherein the thermal printer prints images by transferring ink onto the recording sheet while the recording sheet pinched between the thermal head and the platen roller being conveyed by the rotation of the conveying roller, and the conveying roller is arranged upstream the platen roller in a feeding direction of the recording sheet ranging from a feed side toward a discharge side, and
wherein the platen roller can convey the recording sheet at least in the feeding direction by its rotation, and the printing is performed while the recording sheet being conveyed in the feeding direction by the cooperation of the conveying roller with the platen roller.

2. The printer according to claim 1, wherein the recording sheet is conveyed while a tension being applied to the recording sheet during printing by the cooperation of the conveying roller with the platen roller.

3. The printer according to claim 1, wherein the heating element of the thermal head is driven by turning on electricity before the recording sheet is pinched between the thermal head and the platen roller.

4. The printer according to claim 1, further comprising a guide member arranged between the conveying roller and the platen roller for restricting positions on the front face and rear face side of the recording sheet.

5. The printer according to claim 1, further comprising curl correcting means capable of bending the recording sheet in a direction opposite to that of curl produced in the recording sheet,
wherein the curl correcting means is arranged downstream the platen roller in the feeding direction of the recording sheet as well as at a position where after heat due to the thermal head during ink transferring remains in the recording sheet.

6. A thermal printer comprising:
a conveying roller for conveying a recording sheet;
a thermal head for transferring ink on an ink ribbon onto the recording sheet by driving a heating element with turning on electricity; and
a platen roller arranged to oppose the thermal head for pinching the ink ribbon and the recording sheet between the platen roller and the thermal head during ink transferring,
wherein the thermal printer prints images by transferring ink onto the recording sheet while the recording sheet pinched between the thermal head and the platen roller being conveyed by the rotation of the conveying roller, and the conveying roller is arranged upstream the platen roller in a feeding direction of the recording sheet ranging from a feed side toward a discharge side, and
wherein the thermal printer further includes a pair of upper and lower guide members arranged between the conveying roller and the platen roller for restricting positions on the front face and rear face side of the recording sheet, and the thermal printer prints images while the recording sheet being conveyed by the rotation of the conveying roller in the feeding direction of the recording sheet via between the guide members.

7. The printer according to claim 6, wherein at least part of the guide members is formed in parallel with a tangent line connecting between the conveying roller and the platen roller.

8. A printing method of a thermal printer that includes a conveying roller for conveying a recording sheet, a thermal head for transferring ink on an ink ribbon onto the recording sheet by driving a heating element with turning on electricity, and a platen roller arranged to oppose the thermal head for pinching the ink ribbon and the recording sheet between the platen roller and the thermal head during ink transferring, for printing images by transferring ink onto the recording sheet while the recording sheet pinched between the thermal head and the platen roller being conveyed by the rotation of the conveying roller, the printing method comprising the steps of:
arranging the conveying roller upstream the platen roller in a feeding direction of the recording sheet ranging from a feeding side toward a discharge side;
conveying the recording sheet at least in the feeding direction by the rotation of the platen roller; and
printing images while the recording sheet being conveyed in the feeding direction by the cooperation of the conveying roller with the platen roller.

9. A printing method of a thermal printer that includes a conveying roller for conveying a recording sheet, a thermal head for transferring ink on an ink ribbon onto the recording sheet by driving a heating element with turning on electricity, and a platen roller arranged to oppose the thermal head for pinching the ink ribbon and the recording sheet between the platen roller and the thermal head during ink transferring, the thermal printer being for printing images by transferring ink onto the recording sheet while the recording sheet pinched between the thermal head and the platen roller being conveyed by the rotation of the conveying roller, the printing method comprising the steps of:
arranging the conveying roller upstream the platen roller in a feeding direction of the recording sheet ranging from a feeding side toward a discharge side;
arranging a pair of upper and lower guide members between the conveying roller and the platen roller for restricting positions on the front face and rear face side of the recording sheet; and
printing images while the recording sheet being conveyed by the rotation of the conveying roller in the feeding direction of the recording sheet, and the positions of the recording sheet being restricted with the guide members.
